(19) United States
(12) Patent Application Publication
(10) Pub. No.: US 2010/0078261 A1
(43) Pub. Date: Apr. 1, 2010

(54) FALL ARREST SYSTEM

(75) Inventors: Jesse Travis WATTS, Brunswick, GA (US); Timothy J. Anthony, Conyers, GA (US)

Correspondence Address: TROUTMAN SANDERS LLP;5200 BANK OF AMERICA PLAZA, 600 PEACHTREE STREET, N.E., SUITE 5200, ATLANTA, GA, 30308-2216, US

(73) Assignee: The Southern Company, Atlanta, GA (US)

(21) Appl. No.: 12/570,600

(22) Filed: Sep. 30, 2009

Related U.S. Application Data
(60) Provisional application No. 61/101,754, filed on Oct. 1, 2008.

(51) Int. Cl. A62B 35/00

(52) U.S. Cl. 182/9

(57) ABSTRACT

A fall arrest system adapted to prevent falls while climbing structures. A fall arrest system adapted to prevent lineman from falling from power poles during maintenance or repairs to various elements associated with the suspension and switching on transmission and/or distribution power grids. The system can comprise a safety belt type device comprising an inner strap assembly and an outer strap assembly for encircling a structure to be climbed. The system can comprise many materials in order to meet certain criteria, such as strength and/or stiffness. Additionally, the system can be easily manipulated as the user climbs up or down the structure to maintain the proper angle of the belt with respect to the user.

### CROSS-REFERENCE TO RELATED APPLICATIONS AND PRIORITY CLAIM

This application claims the benefit, under 35 U.S.C. §119(e), of U.S. Provisional Patent Application No. 61/101,754, filed 1 Oct. 2008, the entire contents and substance of which is incorporated herein by reference in its entirety as if fully set forth below.

### BACKGROUND

Embodiments of the present invention generally relate to a system for use when climbing a variety of structures, and more specifically, to a system for preventing falls while climbing wooden power poles during the repair and/or maintenance of electrical transmission and distribution lines.

Electrical power distribution and transmission grids (the “grid”) contain a number of components, including but not limited to wires (i.e., conductors), insulators, switches, and transformers. Most of these components must be serviced on a regular basis, and replaced when necessary. For safety and security reasons, these components are generally attached to power poles, which can be, for example, wood, concrete, or aluminum, of suitable size and strength to support the intended load. Power poles can vary from approximately 15-30 feet tall for local distribution grids to over 100 feet tall for high-voltage power transmission lines.

Repairs to components on the poles are often carried out using a service vehicle with a crane, commonly referred to as a bucket truck. A bucket truck has a large lifting arm, or crane, that can be electrically or hydraulically powered, with a bucket on one end. The bucket provides an area in which a lineman can stand and can include controls for the crane. The crane is capable of lifting the lineman and his equipment up to the repair area.

In some instances, however, power poles may be located in areas that are, for example, too remote or uneven to access with a bucket truck, or other equipment. In these locations, it can be necessary for the lineman to climb the pole manually to affect repairs. In this case, the lineman can use spikes attached to his work boots or steps provided on the power pole to climb the pole. Due to the height of the pole, however, it is desirable to have safety harness or belt to catch the lineman in the event of a fall.

Conventionally, these safety harnesses consist of two components, a harness, and a safety belt worn by lineman. The harness generally attaches around the lineman's waist and/or upper thighs, similar to harnesses used by rock climbers and mountaineers. The safety belt generally consists of a nylon strap, or other means, that is wrapped around the power pole and affixed to the lineman's harness. Conventional safety belt designs are subject to excessive wear from the power pole and, due to their materials, often require the lineman to assume dangerous positions, with respect to the pole, to adjust the position of the safety belt on the pole as they climb up or down.

### SUMMARY

Embodiments of the present invention can comprise a fall arrest system for use when climbing structures and preventing falls therefrom. In some embodiments, the system can comprise a belt assembly attachable to a user's safety harness. Embodiments of the present invention can comprise a fall arrest system comprising an outer strap assembly comprising a first outer strap, the first outer strap comprising a first end which is free-floating and a second end which is free-floating; an inner strap assembly comprising a first inner strap and a second inner strap, a second end of the first inner strap coupleable to a second end of the second inner strap; a first bracket in communication with the outer strap assembly, the first bracket defining a first aperture; and a second bracket in communication with the outer strap assembly, the second bracket defining a second aperture; wherein the first aperture receives the first inner strap; wherein the second aperture receives the second inner strap; and wherein a portion of the first outer strap, a portion of the first inner strap, and a portion of the second inner strap collectively form a loop for surrounding a structure.

In some embodiments, the inner strap assembly further comprises a coupling assembly for detachably coupling the second ends of the first inner strap and the second inner strap. The system can further comprise an attachment means that further comprises: a coupling assembly for detachably coupling the system to a harness on a user; and a lock for fixing the location of the coupling assembly along the inner strap assembly. In some embodiments, the outer strap can further comprise: a second outer strap comprising a first end and a second end, the first end of the second outer strap being free-floating; an adjusting element comprising a first end and a second end, the first end of the adjusting element pivotally coupled to a second end of the first bracket, and the second end of the adjusting element slideably engageable with the second outer strap; wherein a portion of the first bracket is coupled in proximity to the second end of the first outer strap; wherein the second bracket is coupled to the second outer strap and disposed between the first end and the second end of the second outer strap; wherein the size of the loop can be adjusted by sliding the second outer strap when the adjusting element is in a first, unlocked, position; and wherein the size of the loop can be fixed when the adjusting element is in a second, locked, position, thereby preventing the second outer strap from sliding within the adjusting element.

The free-floating first ends of the first and second outer straps can provide handles with which a user can manipulate the fall arrest system. In some embodiments, one or more of the first and second brackets further comprise a friction multiplier to increase the friction of the brackets against the structure. The second end of the second outer strap can further comprise a stop for preventing the second outer strap from disengaging from the adjusting element. In some embodiments, the inner strap assembly can further comprise one or more handles located proximate the second ends of the inner straps for retracting the inner strap assembly away from the second side of the structure for temporarily increasing the size of the loop.

Embodiments of the invention can also comprise a method of placing a fall arrest system around a structure, the fall arrest system comprising an inner strap assembly and an outer strap assembly. The method comprises: adjusting the length of the outer strap assembly to substantially encircle a first side of the structure; coupling a first strap of the inner strap assembly to a second strap of the inner strap assembly, wherein the inner strap assembly substantially encircles a second side of the structure, and wherein the inner strap assembly and the outer strap assembly substantially form a loop that encircles both sides of the structure; and coupling the inner strap assembly to a harness on a user such that the user's weight substantially closes the loop around the structure.

The method can further comprise: adjusting the angle of the user with respect to the structure by adjusting the length of the inner strap assembly wherein it couples to the harness. The method can further comprise: grasping a first free-floating end and a second free-floating end of the outer strap assembly; grasping the inner strap assembly and retracting it away from the second side of the structure; repositioning the outer strap assembly using the first free-floating end and the second free-floating end to maintain the position of the safety belt relative to the user as he climbs up or down the structure; and releasing the inner strap assembly such that the user's weight substantially closes the loop around the structure.

In some embodiments, the inner strap assembly can further comprise one or more handles for retracting the inner strap assembly away from the second side of the structure. The system can be coupled to the harness using one or more coupling assemblies disposed on the inner strap assembly and outside the outer strap assembly.

Embodiments of the invention can also comprise a fall arrest system detachably coupleable to a harness on a user for preventing a user from falling off a structure, the system comprising: an outer strap assembly comprising a first outer strap comprising a first end and a second end, the first end of the first outer strap being free-floating; a second outer strap comprising a first end and a second end, the first end of the second outer strap being free-floating; a first bracket comprising a first end and a second end and defining a first aperture, the first end of the first bracket coupled in proximity to the second end of the first outer strap; an adjusting element comprising a first end and a second end, the first end of the adjusting element pivotally coupled to the second end of the first bracket, and the second end of the adjusting element slideable along a portion of the second outer strap; a second bracket defining a second aperture, coupled to the second outer strap, and disposed between the first end and the second end of the second outer strap; an inner strap assembly comprising a first end, a middle, and a second end, for encircling a second side of the structure, the first end second ends of the inner strap assembly being substantially free-floating; a first attachment means disposed between the first end of the inner strap assembly and the first bracket, for attaching the inner strap assembly to a harness worn by a user; and a second attachment means disposed between the second end of the inner strap assembly and the second bracket, for attaching the inner strap assembly to a harness worn by a user; wherein the inner strap assembly passes through the first aperture and the second aperture, such that the middle of the inner strap assembly is disposed between the first aperture and the second aperture and inside the outer strap assembly; wherein the first and second ends of the inner strap assembly are disposed outside the outer strap assembly, and such that portions of the outer strap assembly and portions of the inner strap assembly substantially form a loop around the structure; wherein the size of the loop can be adjusted by sliding the second outer strap wherein it engages the adjusting element by placing the adjusting element in a first, unlocked, position; and wherein the size of the loop can be fixed by placing the adjusting element in a second, locked, position, thereby preventing the second outer strap from sliding within the adjusting element.

In some embodiments, the inner strap assembly can further comprise: a first inner strap comprising a first end and a second end, the first end of the first inner strap being free-floating; a second inner strap comprising a first end and a second end, the first end of the second inner strap being free-floating; and a coupling assembly detachably coupleable to the second ends of the first and second inner straps; wherein the second ends of the first and second inner straps are disposed inside the outer strap assembly; and wherein the first ends of the first and second inner straps are disposed outside the outer strap assembly.

In some embodiments, the adjusting element can further comprise a cam comprising a first position and a second position; wherein, in the first position the cam enables the second outer strap to move freely in a first direction but prevents movement of the second outer strap in a second direction; and wherein the cam enables the second outer strap to move freely in both the first and second directions in a second position. The system can further comprise one or more handles disposed proximate the second ends of the first and second inner straps for increasing the size of the loop.

The attachment means can further comprise: a coupling assembly comprising a first end and a second end, the first end of the coupling assembly detachably coupleable to the harness; and a lock comprising a first end and a second end, the first end of the lock coupleable to the coupling assembly and the second end of the lock slideably coupleable to the inner strap assembly; wherein in a first position the lock prevents movement of the attachment means along the inner strap assembly; and wherein in a second position the lock enables the attachment means to slide along the inner strap assembly outside the outer strap assembly.

In some embodiments, the lock can further comprise a cam having a first position that enables movement of the attachment means along the inner strap assembly in a first direction, but prevents movement along the inner strap assembly in a second direction; and having a second position that enables movement of the attachment means along the inner strap assembly in both the first and second directions. In some embodiments, one or more of the first and second brackets can further comprise a friction multiplier to increase the friction of the brackets against the structure.

These and other objects, features, and advantages of the present invention will become more apparent upon reading the following specification in conjunction with the accompanying drawings.

### BRIEF DESCRIPTION OF THE FIGURES

FIG. 1 depicts a perspective view of a lineman using a conventional safety belt on a power pole.

FIG. 2 depicts a perspective view of a conventional safety belt.

FIG. 3 depicts a perspective view of a fall arrest system, in accordance with some embodiments of the present invention.

FIG. 4 depicts a close-up, perspective view of an adjusting element of the fall arrest system of FIG. 3, in accordance with some embodiments of the present invention.

FIG. 5 depicts another close-up, perspective view of the adjusting element of the fall arrest system of FIG. 3, in accordance with some embodiments of the present invention.

FIG. 6 depicts a close-up, perspective view of a bracket of the fall arrest system of FIG. 3, including an attachment means, in accordance with some embodiments of the present invention.

FIG. 7 depicts a flow chart for a method of use for the fall arrest system, in accordance with some embodiments of the present invention.

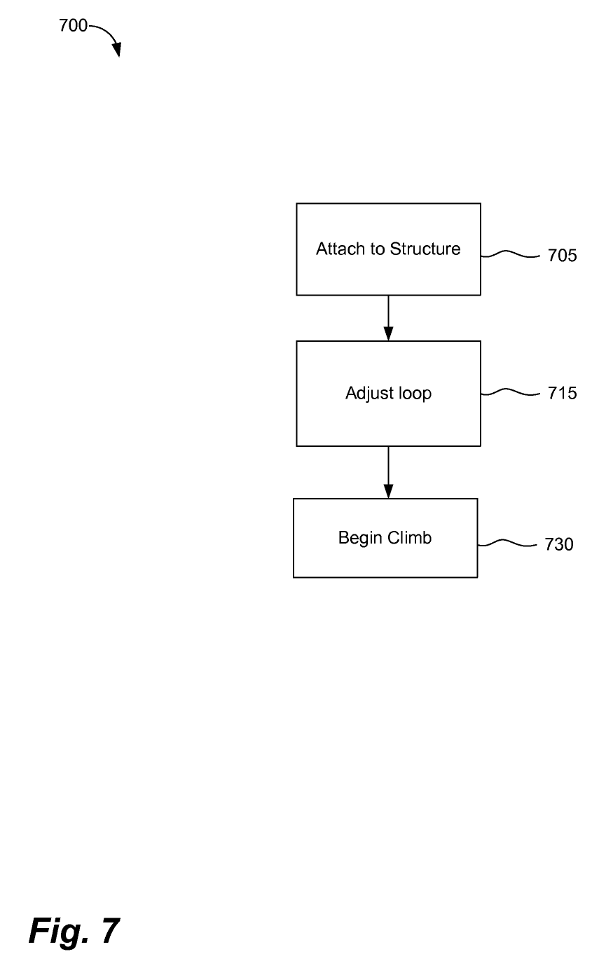

FIG. 8 depicts a flow chart for another method of use for the fall arrest system, in accordance with some embodiments of the present invention.

FIG. 9 depicts a perspective view of the fall arrest system of FIG. 3, being used by a lineman while climbing a power pole, in accordance with some embodiments of the present invention.

FIG. 10 depicts a perspective view of the lineman, who has fallen from the power pole and is hanging from the fall arrest system of FIG. 3, in accordance with some embodiments of the present invention.

### DETAILED DESCRIPTION

Embodiments of the present invention can be understood more readily by reference to the following detailed description and the examples included herein. Before the embodiments of the devices and methods according to the present invention are disclosed and described, it is to be understood that this invention is not limited to the embodiments described within this disclosure. Numerous modifications and variations therein will be apparent to those skilled in the art to remain within the scope of the invention. It is also to be understood that the terminology used herein is for the purpose of describing specific embodiments only, and is not intended to be limiting.

Unless otherwise noted, the terms used herein are to be understood according to conventional usage by those of ordinary skill in the relevant art. In addition to the definitions of terms provided below, it is to be understood that as used in the specification and in the claims, “a” or “an” can mean one or more, depending upon the context in which it is used.

Embodiments of the present invention are directed towards an assembly for supporting a climber, e.g., a lineman, on a climbing structure, e.g., a power pole, and preventing falls therefrom. Embodiments of the present invention, therefore, are directed to a fall arrest system for supporting a lineman during repairs performed on and around a power pole and preventing falls therefrom.

To facilitate an understanding of the principles and features of the invention, it is explained hereinafter with reference to its implementation in an illustrative embodiment. In particular, embodiments of the present invention are described in the context of being a support system for linemen, or a “fall arrest system,” to prevent falls while working on power poles during repairs associated with electrical distribution and transmission grids (“the grid”). In some embodiments, the fall arrest system can provide a compact, easy to deploy system for supporting lineman, during routine maintenance and repair of grid components.

Embodiments of the invention, however, are not limited to use with power grid maintenance and repair. Rather, embodiments of the invention can be used any time a safety system that is easily manipulated is needed to prevent falls from structures. Thus, the fall arrest system described herein after can also find utility, for example and not limitation, in logging or timber operations, police and ranger applications, and generally in climbing sports.

The materials described hereinafter as making up the various elements of the fall arrest system of the invention are intended to be illustrative and not restrictive. Many suitable materials that would perform the same or a similar function as the materials described herein are intended to be embraced within the scope of the invention. Such other materials not described herein can include, but are not limited to, materials that are developed after the time of the development of the invention, for example.

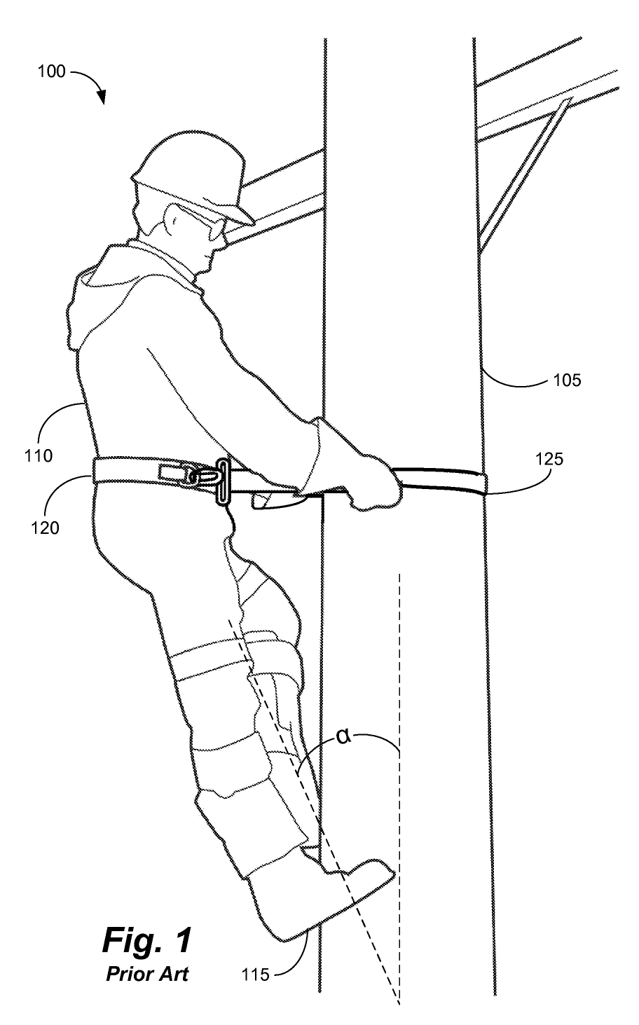

Referring now to the figures, FIG. 1 illustrates a work area 100, which implements one of many possible combinations of elements on a conventional power pole 105. The power pole 105 can be constructed of a variety of materials such as wood, fiberglass, aluminum, and so on. The pole 105 is generally sufficiently anchored to the ground to support the weight of various elements. The pole 105 may be driven into the ground, set in concrete, stabilized with guy-wires, and so on, depending on soil conditions, the number, and weight of elements to be supported, and so forth.

FIG. 1 illustrates one possible configuration of a power pole 105 with a lineman 110 thereon. The lineman 110 can be supported by spikes or other means attached to his boots 115. In some embodiments, the boots 115 comprise built-in spikes, which can be used to penetrate the power pole 105 to provide support for the lineman 110. In some embodiments, the lineman can use spikes that strap or clamp to his boots 115, but can be removed when not in use.

In another possible configuration, the power pole 105 can include rungs (not shown). In some embodiments, the pole 105 can include rungs that begin sufficiently high above ground to prevent climbing by the casual passerby. In some embodiments, the lineman 110 may be required to use a ladder to reach the first rung and then can proceed up the pole 105 using successive rungs. This can be necessary, for example, when the pole 105 is constructed of a material that is not compatible for use with spikes, e.g., a metal or fiberglass pole 105.

Regardless of the method used to climb the pole 105, a means is necessary to prevent the lineman 110 from falling from the pole 105. Conventionally, this is done, in part, using a harness 120 fitted around the waist of the lineman 110. The harness 120 can comprise a sufficiently strong, flexible material, such as for example and not limitation, nylon webbing or leather straps. The harness 120 can comprise a waist belt and in some instances may also comprise leg straps and/or crotch straps for additional security. In some embodiments, the harness 120 can be similar to harnesses commonly used in rock climbing or other climbing sports. Conventionally, the harness 120 is then attached to a safety belt 125.

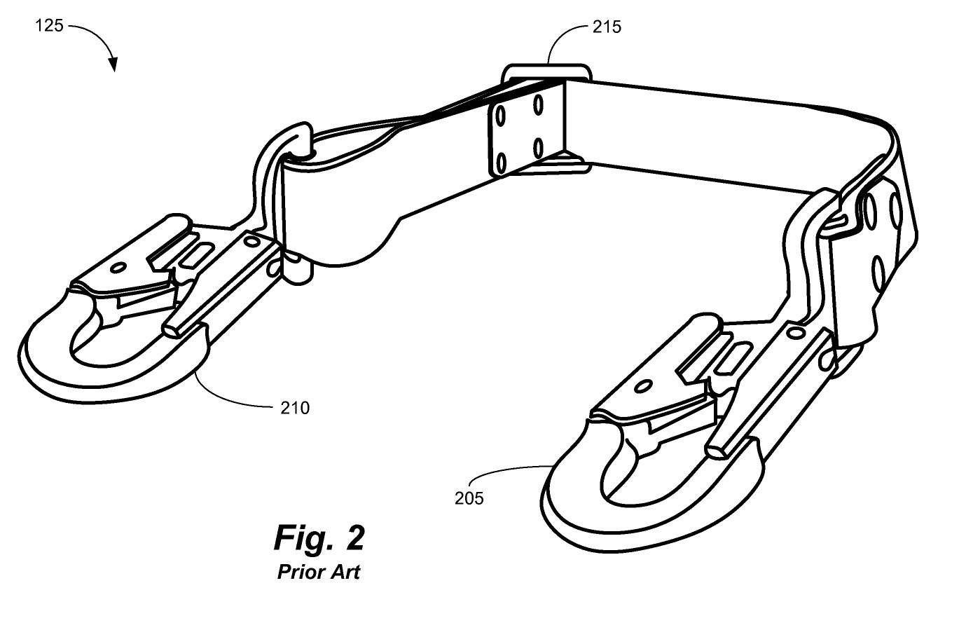

As shown in FIG. 2, the safety belt 125 can be sufficiently long to wrap around the pole 105 and can attach to the harness 120 using one or more locking mechanisms 205, 210 such as, for example and not limitation, carabiners, locking carabiners, or snap hooks. The safety belt 125 can comprise a sufficiently strong material to support the weight of the lineman 110 during a fall. The safety belt 125 can comprise, for example and not limitation, nylon or polyester webbing riveted to the locking mechanisms 205, 210 and can further comprise an adjuster 215 for adjusting the length of the belt 125. The adjuster 215 can comprise, for example and not limitation, a buckle, bracket, or cam that can enable the length of the belt 125 to be adjusted for different sized linemen 110 and/or poles 105.

Prior to climbing the pole 105, the lineman 110 can attach the first locking mechanism 205 to his harness 120, place the safety belt 125 around the pole 105, and then attach the second locking mechanism 210 to his harness 120. The lineman 110 can then lean against the safety belt 125, at an angle α, and begins his climb up the pole 105. Then the lineman 110 can the hitch the safety belt 125 up and down the pole 105 as he climbs.

For example, as he moves up the pole 105, the lineman 110 moves the safety belt 125 up the pole 105 with him in an attempt to keep his angle α relative to the pole 105 relatively consistent. This angle α places some of the lineman's weight on the safety belt 125, which, in turn, creates a frictional force between the safety belt 125 and the back of the pole 105. This can increase the lineman's stability as he climbs the pole 105. This frictional force can also help slow, or stop, the lineman 110 if he, for example, loses his footing on the pole 105 and falls.

The safety belt 125 is intended to frictionally arrest, or at least slow, a fall from the pole 105. If the lineman 110 falls such that the angle α is substantially maintained, the safety belt 125 can cock as the lineman 110 falls, creating sufficient friction between the safety belt 125 and the pole 105 to arrest his fall. If, on the other hand, the lineman 110 falls while his body is substantially parallel to the pole 105, i.e. such that his body is less than a relative to the pole, the safety belt 125 can provide little friction as is slides down the back side of the pole 105. In this instance, the lineman 110 must hope that the safety belt 125 snags, or catches, on a protrusion on the pole 105 on the way down, or, at a minimum, frictionally slows his fall enough to prevent injury.

As mentioned above, conventionally safety belts 125 have been manufactured from relatively pliable material, such as nylon or polyester webbing. Webbing is incredibly strong, light, and pliable. For instance, one inch polyester webbing can support up to 1500 pounds. It is not the strength of webbing but its pliability, however, which makes it ill suited for safety harnesses 125.

As the lineman 110 climbs the pole 105, he must reposition the safety belt 125 to maintain the position of the safety belt 125 relative to his body and the pole 105. This maintains the necessary angle α to place some of his weight on the safety belt 125, which frictionally retains the safety belt 125 on the back of the pole 105. Unfortunately, due to the relatively pliable nature of conventional webbing, the safety belt 125 can have a tendency to fold, roll, or snag on the pole 105 when the lineman 110 attempts to move it up or down the pole 105.

In order to unfold or free the safety belt 125, the lineman 110 must lean in, reach around the back of the pole 105, and manipulate the webbing to continue. As the lineman 110 leans in to remedy the situation, his angle α relative to the pole 105, and thus the frictional force between the belt 125 and the pole 105, tends towards zero. If the lineman 110 falls during this maneuver, the safety belt 125 will have very little chance to arrest, or even slow, his fall.

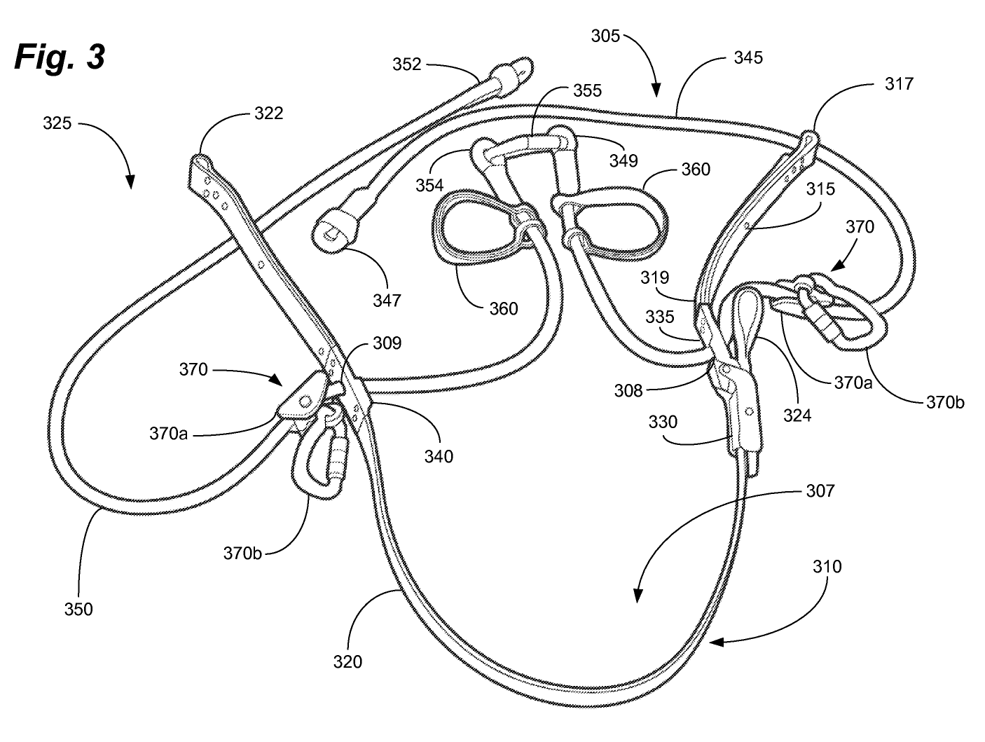

Embodiments of the present invention, shown in FIG. 3, therefore, are directed to a fall arrest system 325, for climbing a variety of structures, with improved handling and safety features. In some embodiments, the system 325 can comprise an inner strap assembly 305 and an outer strap assembly 310. In some embodiments, the inner strap assembly 305 and the outer strap assembly 310 can be coupled and can substantially form a loop 307, which can encircle the object to be climbed, e.g. a pole 105.

In some embodiments, the outer strap assembly 310 can comprise a first outer strap 315 and a second outer strap 320. The first outer strap 315 can have a first end 317 and a second end 319. The first end 317 can be free-floating. The second end 319 can be pivotally coupled to an adjusting element 330 via a first bracket 335.

The second outer strap 320 can have a first end 322 and a second end 324. In some embodiments, the second outer strap 320 can further comprise a second bracket 340 disposed between the first end 322 and the second end 324. In some embodiments, the first end 322 can be free-floating. In some embodiments, a portion of the second outer strap 320, e.g., the portion of the second outer strap 320 between the second end 324 and the second bracket 340, can pass through, and be slideably engaged with, the adjusting element 330. This can enable the second outer strap 320 to be frictionally coupled to the first outer strap 315. The second end 324 of the second outer strap 320 may further comprise a loop, or other means, to prevent the second end 324 from pulling out of the adjusting element 330 during use.

In some embodiments, the outer strap assembly 310 can comprise a strong, stiff, yet flexible material. For example, the first outer strap 315 and the second outer strap 320 can comprise this material. Examples include, but are not limited to, nylon or polypropylene webbing, reinforced fabric, leather, polyester, plastic, rubber, metal and/or combination thereof. The material of the outer strap assembly 310 can be stiff enough to enable the outer strap assembly 310 to be manipulated using the first ends 317, 322, yet flexible enough to wrap around, and conform to, the pole 105.

In some embodiments, the inner strap assembly 305 can comprise a supple, yet strong material, such as, for example and not limitation, rope or cord comprising nylon, polyester, Kevlar, cotton, or combinations thereof. For example, the first inner strap 345 and the second inner strap 350 can comprise this material. In some embodiments, the inner strap assembly 305 can further comprise a first inner strap 345, comprising a first end 347 and a second end 349, and a second inner strap 350, comprising a first end 352 and a second end 354. In some embodiments, the first inner strap 345 and the second inner strap 350 can be free-floating on their first ends 347, 352 and can be detachably coupled at their second ends 349, 354 to a coupler 355. In some embodiments, the coupler 355 can comprise, for example and not limitation, a caribiner, a locking caribiner, or a snap hook.

The first and second inner straps 345, 350 can further comprise loops, or handles, 360. In some embodiments, the handles 360 can enable the lineman 110 to more easily manipulate the inner straps 345, 350. In some embodiments, the lineman 110 can use the handles 360 to pull the inner straps 345, 350 away from the pole 105 slightly to facilitate moving the system 325 up or down the pole 105.

In some embodiments, the first and second inner straps 345, 350 can pass through apertures 308, 309 in the brackets 335, 340 in the outer strap assembly 310 such that the inner strap assembly 305 and the outer strap assembly 310 define a space 307, or loop, therebetween. In some embodiments, the inner straps 345, 350 can pass through, and be slideably engaged with, a fastening means 370. In some embodiments, the fastening means 370 can enable the system 325 to be attached to the lineman's harness 120.

In some embodiments, the fastening means 370 can comprise a lock 370a and a coupler 370b. The lock 370a can have a first position and a second position. In the first position, the lock 370a can slide along the inner straps 345, 350 and can move along the between the first end 347,352 and the brackets 335, 340, and in the second position, the lock 370a can frictionally engage the inner straps 345,350 such that the fastening means 370 is substantially fixed along the inner straps 345, 350. In some embodiments, the lock 370a can have a one-way locking effect in which, in the first position, it can slide along the inner straps 345, 350 in a first direction but not in a second direction, yet slide in both directions in the second position. In other words, in some embodiments, the lock 370a can comprise a cam or a pawl that enables travel in only one direction unless released (i.e., placed in the second position).

The coupler 370b can comprise, for example and not limitation, a caribiner, a locking caribiner, a snap ring, or a snap hook. The coupler 370b can enable the system 325 to be attached to the lineman's harness 120 via the lock 370a and the inner straps 345, 350. In other words, in some embodiments, the lock 370a can be slideably engaged with the inner straps 345, 350 and can comprise an eye, loop, bracket, or other means, for attaching the coupler 370b. The axial centerline of the hole of the eye or loop can be disposed approximately normal to the lock 370a, and thus the inner straps 345,350.

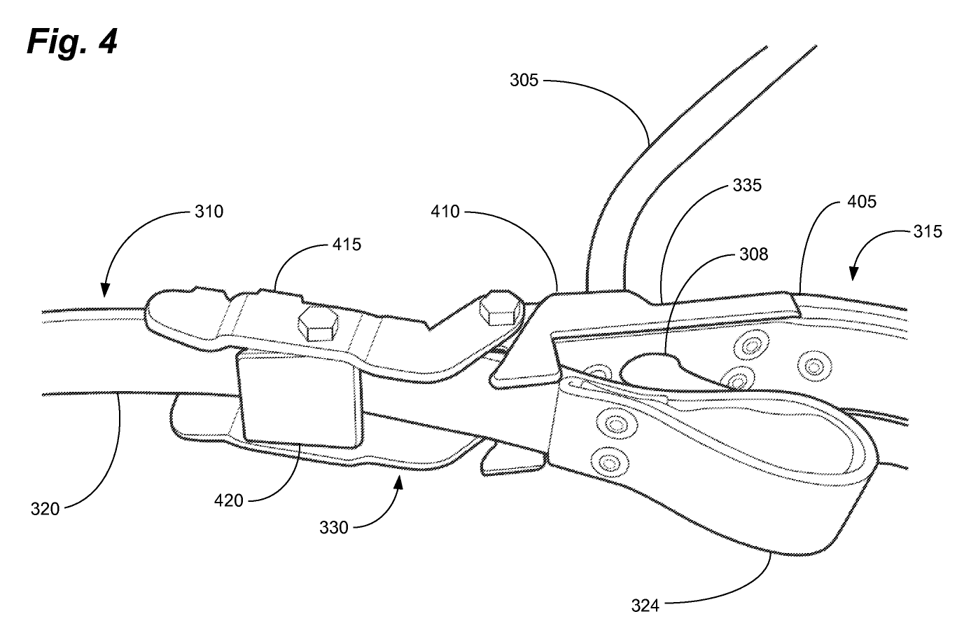

As shown in greater detail in FIG. 4, the system 325 can comprise an inner strap assembly 305 and an outer strap assembly 310. In some embodiments, the outer strap assembly 310 can comprise a first outer strap 315 and a second outer strap 320. In some embodiments, the first outer strap 315 can be in communication with a first bracket 335 with a first end 405 and a second end 410. In some embodiments, the first end 405 of the first bracket 335 can be attached to the first outer strap 315 using, for example and not limitation, rivets, bolts, or adhesive. In some embodiments, the second end 410 of the first bracket 335 can be pivotally coupled to the adjusting element 330.

The adjusting element 330 can comprise a body 415 and a locking mechanism 420. The locking mechanism 420 can have a first position and a second position. In the first position, the locking mechanism 420 can enable the adjusting element 330 to slide along the second outer strap 320 between the first end 322 and the second bracket 340 (See, e.g., FIG. 3), and in the second position, the locking mechanism 420 can frictionally engage the second outer strap 320 such that the adjusting element 330 is substantially fixed along the second outer strap 320. The locking mechanism 420 can have a one-way locking effect in which, in the first position, the adjusting element 330 can slide along the second outer strap 320 in one direction but not the other, yet slide in both directions in the second position. In other words, in some embodiments, the locking mechanism 420 can comprise a cam or a pawl that enables travel in only one direction unless released (i.e., placed in the second position).

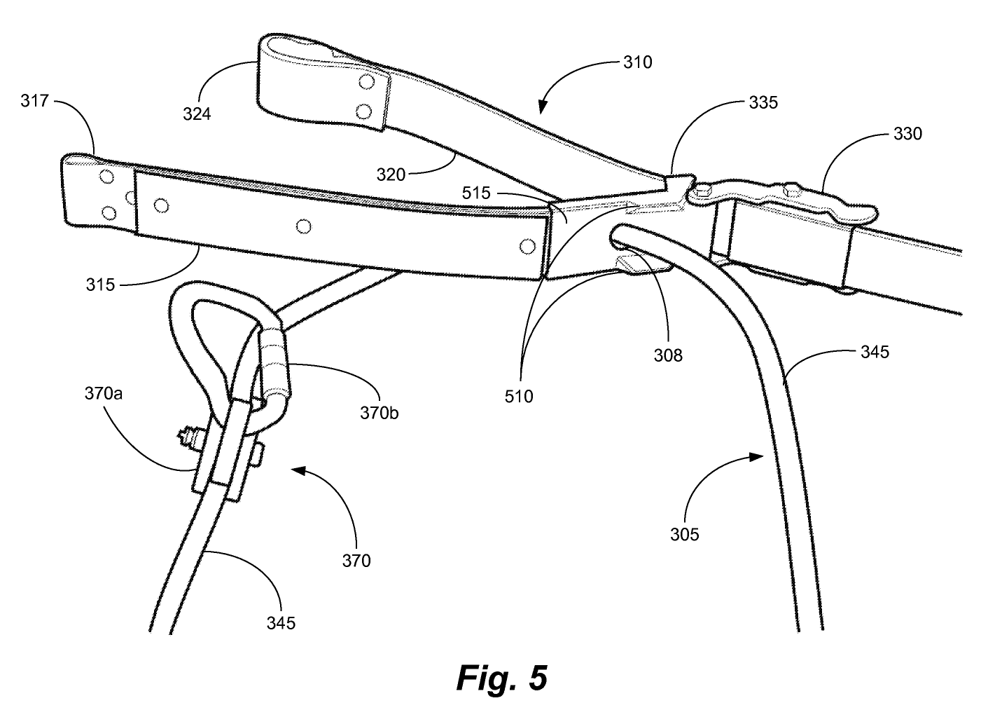

As can be seen in FIG. 5, the first inner strap 345 can pass through an aperture 308 in the first bracket 335. In some embodiments, the first bracket 335 can comprise, for example and not limitation, a metal or plastic. In some embodiments, the aperture 308 in the first bracket 335 can act as a bearing surface for the first inner strap 345. In other words, the aperture 308 can, for example, be smooth or have chamfered edges to prevent wear on the first inner strap 345. The aperture 308 can further comprise a separate bearing or washer (not shown) for this purpose.

In some embodiments, the first bracket 335 can further comprise one or more friction multipliers 510 located on an inner face 515. In some embodiments, the friction multipliers 510 can be integral to the inner face 515 of the first bracket 335. In other embodiments, the friction multipliers 510 can be, for example and not limitation, welded, bolted, or attached to the inner face 515 of the first bracket 335 using adhesive. In some embodiments, as shown in FIG. 5, the friction multipliers 510 can comprise ramps molded or attached to the inner face 515 of the first bracket 335. In other embodiments, the friction multipliers 510 can comprise, for example and not limitation, ridges, teeth, nipples, or grooves.

In the case of a fall, the lineman's weight can be applied to the inner strap assembly 305 of the system 325 via the fastening means 370. The can achieve at least two effects: 1) his weight tightens the loop 307 around the pole 105 and 2) his weight forces the inner face 515 of the first bracket 335, and thus the friction multipliers 510, against the pole 105. The friction multipliers 510 can then considerably increase the frictional force the first bracket 335 applies to the pole 105 over, for example, a first bracket 335 with a smooth inner face 515. The friction multipliers 510 can help the system 325 arrest the lineman's fall more quickly by supplementing the frictional force exerted by the inner 305 and outer 310 portions of the system 325 on the pole.

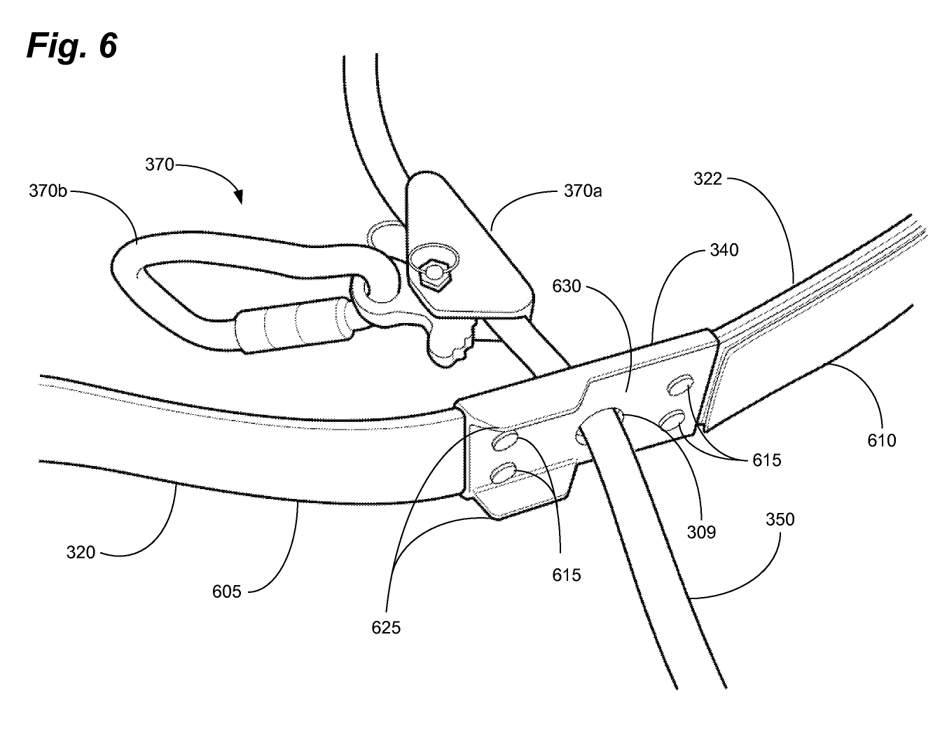

Shown in detail in FIG. 6, the second outer strap 320 can be coupled to the second bracket 340 using fasteners 615, which can comprise, for example and not limitation, rivets, bolts, or screws. In some embodiments, the second bracket 340 can be affixed to the second outer strap 320 using, for example, an adhesive. In some embodiments, the second outer strap 320 can comprise a first portion 605 and a second portion 610 coupled by the second bracket 340. The second outer strap 320 can comprise a continuous piece of material with the second bracket 340 affixed thereto, which can increase the strength of the second outer strap 320 and reduce stress on the second bracket 340 and the fasteners 615.

The second inner strap 350 can pass through an aperture 309 in the second bracket 340 and the second outer strap 320. The second bracket 340 can comprise, for example and not limitation, metal or plastic. The aperture 309 in the second bracket 340 can act as a bearing surface for the second inner strap 350. In other words, the aperture 309 can, for example, be smooth or have chamfered edges to prevent wear on the second inner strap 350. In some embodiments, the aperture 309 can further comprise a separate bearing or washer for this purpose.

In some embodiments, the second bracket 340 can further comprise one or more friction multipliers 625 located on an inner face 630. In some embodiments, the friction multipliers 625 can be integral to the inner face 630 of the second bracket 340. In other embodiments, the friction multipliers 625 can be, for example and not limitation, welded, bolted, or attached to the inner face 630 of the second bracket 340 using adhesive. In some embodiments, as shown in FIG. 5, the friction multipliers 625 can comprise ramps molded or attached to the inner face 630 of the second bracket 340. In other embodiments, the friction multipliers 625 can comprise, for example and not limitation, ridges, teeth, nipples, or grooves.

In the case of a fall, the lineman's weight can be applied to the inner strap assembly 305 of the system 325 via the fastening means 370. The can achieve at least two effects: 1) his weight tightens the loop 307 around the pole 105 and 2) his weight forces the inner face 630 of the second bracket 340, and thus the friction multipliers 625, against the pole 105. The friction multipliers 625 can then considerably increase the frictional force the second bracket 340 applies to the pole 105 over, for example, a second bracket 340 with a smooth inner face 630. The friction multipliers 625 can help the system 325 arrest the lineman's fall more quickly by supplementing the frictional force exerted by the inner 305 and outer 310 portions of the system 325 on the pole.

Embodiments of the present invention can also comprise a method 700 for using the system 325. In some embodiments, the lineman 110 can approach the pole 105 to be climbed and place the system 325 around the structure. At 705, method 700 begins with attaching the system 325 to the structure to be climbed. In some embodiments, this can be accomplished by removing one of the second ends 349, 354 from the coupler 355 and placing the system 325 around the pole 105, such that the pole 105 is disposed inside the loop 307 of the system 325. The lineman 110 can then insert the second end 349, 354 back into the coupler 355.

At 715, the loop around the structure can be adjusted. The size of the outside of the loop 307 can be adjusted by loosening the adjusting element 330 and extending or retracting the outer strap assembly 310 until the desired wrap is achieved. The lineman 110 can then attach the system 325 to both sides of his harness 120 using the couplers 370b on the fastening means 370.

While still on the ground or at a safe height, i.e., one or two steps of the ground, the lineman 110 can adjust his angle α with respect to the pole 105 by changing the position of the inner straps 345, 350 within the locks 370a. In some embodiments, such as when the one-way lock 370a describe above is used, this can be achieved by simply pulling on the first ends 347, 352 of the inner straps 345, 350. In some embodiments, it may be necessary to release the locks 370a by pressing, for example, a lever or button. This adjustment achieves two ends: 1) it sets the lineman's angle α relative to the pole 105 and 2) it tightens the inner strap assembly 305 of the system 325 around the pole 105. At 730, the lineman 110 can then begin his climb up the pole 105.

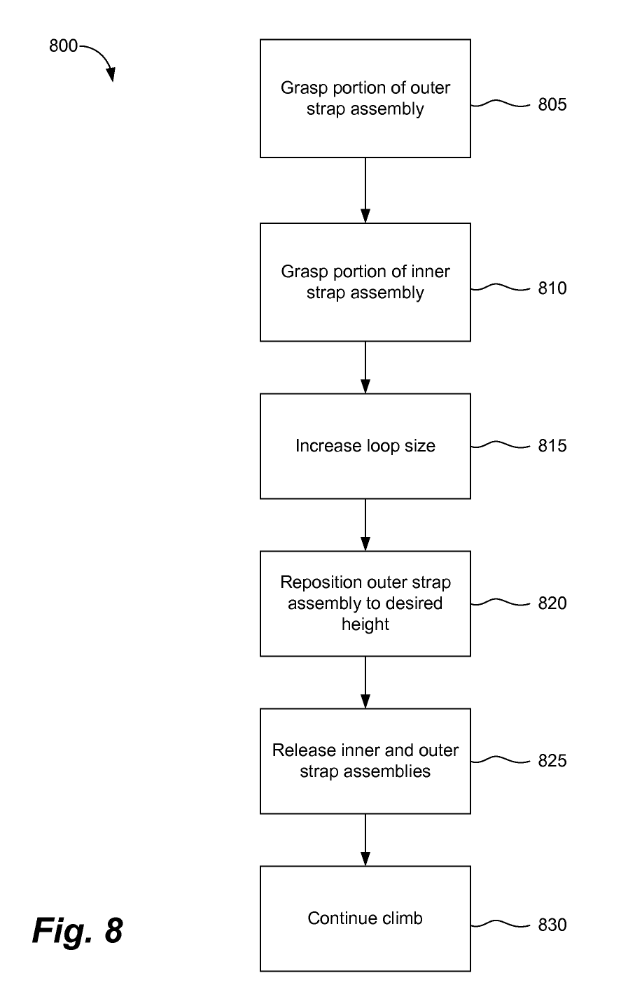

As the lineman 110 ascends the pole 105, it can be necessary for him to reposition the system 325 to maintain its position relative to him. The method 800, as shown in FIG. 8, comprises a way for the lineman 110 to reposition the system 325 as he ascends or descends the pole 105. At 805, the lineman 110 can grasp a portion of the outer strap assembly 310. In some embodiments, repositioning can be achieved by grasping the system 325 in both hands by the first ends 317, 322 of the outer strap assembly 310.

At 810, the lineman 110 can grasp a portion of the inner strap assembly 305. Without removing his hands from the system 325, the lineman 110 can also grasp the handles 360 near the second ends 349, 354 of the inner strap assembly 305. Next, at 815, the lineman 110 can increase the size of the loop 307. In other words, the lineman 110 can pull the inner strap assembly 305 towards his body, i.e., away from the pole 105. This can temporarily increase the size of the loop 307 around the pole 105 and allow the belt to be repositioned more easily.

As mentioned above, the outer strap assembly 310 of the belt comprises a relatively stiff material. At 820, the lineman 110 can next reposition the outer strap assembly 310 up or down the structure. The lineman 110 can “flip” the back side of the system 325 up the pole 105, effectively using the first ends 317, 322 of the outer strap assembly 310 as levers. The stiffness of the outer strap assembly 310, coupled with the extra space created by retracting the inner strap assembly 305 can enable the lineman 110 to move the outer strap assembly 310 past obstacles that may be located on the pole 105. In some embodiments, these obstacles can comprise, for example and not limitation, wire mesh placed on the pole 105 to prevent bird or insect damage, rungs, nails, bolts, electrical components, burrs, splinters, or cracks in the pole 105.

This enables the lineman 110 to reposition the belt without having to reach around the back of the pole 105. As mentioned above, reaching around the pole 105 to untwist or free the outer strap assembly 310 can cause the lineman's angle α with respect to the pole 105 to be reduced. This can, in turn, create a situation in which the system 325 becomes unloaded and is less effective, should the lineman 110 fall.

At 825, once the outer strap assembly 310 reaches a desired height, the lineman 110 can release the inner and outer strap assemblies. After repositioning the outer strap assembly 310 on the pole 105, the lineman 110 can then release the handles 360 and his weight naturally pulls the loop 307 tight around the pole 105. Then, at 830, the lineman 110 is now free to continue his climb. This method 800 can be repeated until the lineman reaches the desired height on the pole 105. This method 800 can be similarly effective at climbing down the pole 105, with the exception that the lineman 110 is then flipping the outer strap assembly 310 of the system 325 down the pole 105 at 820, instead of up the pole 105.

It should be noted that the lineman 110 decreases his angle α with respect to the pole 105 slightly when he pulls on the handles 360 to increase the size of the loop 307. In other words, to pull the second ends 349, 354 of the inner strap assembly 305 out, he necessarily pulls the fastening means 370, and thus himself, in slightly. This change in α is much smaller than would be necessary if the lineman 110 has to reach around the back side of the pole 105. Additionally, because the lineman 110 is attached to the system 325 via the inner strap assembly 305, rather than the outer strap assembly 310, if the lineman 110 were to lose his footing and begin to fall, his weight naturally pulls the inner strap assembly 305 tight again around the pole.

Embodiments of the present invention enable the lineman 110 to proceed up or down the pole 105, moving the system 325 up or down with him, while maintaining his angle α with respect to the pole 105 within a narrow, i.e., safe, range. Additionally, because the lineman 110 is attached to the system 325 via the inner strap assembly 305 rather than the outer strap assembly 310, if he falls, his weight naturally tightens the loop 307 around the pole 105 and arrests his fall. As a result, embodiments of the present invention enable the lineman 110 to maintain a consistent angle α with respect to the pole 105 and provide a system 325 that is less sensitive to changes in α.

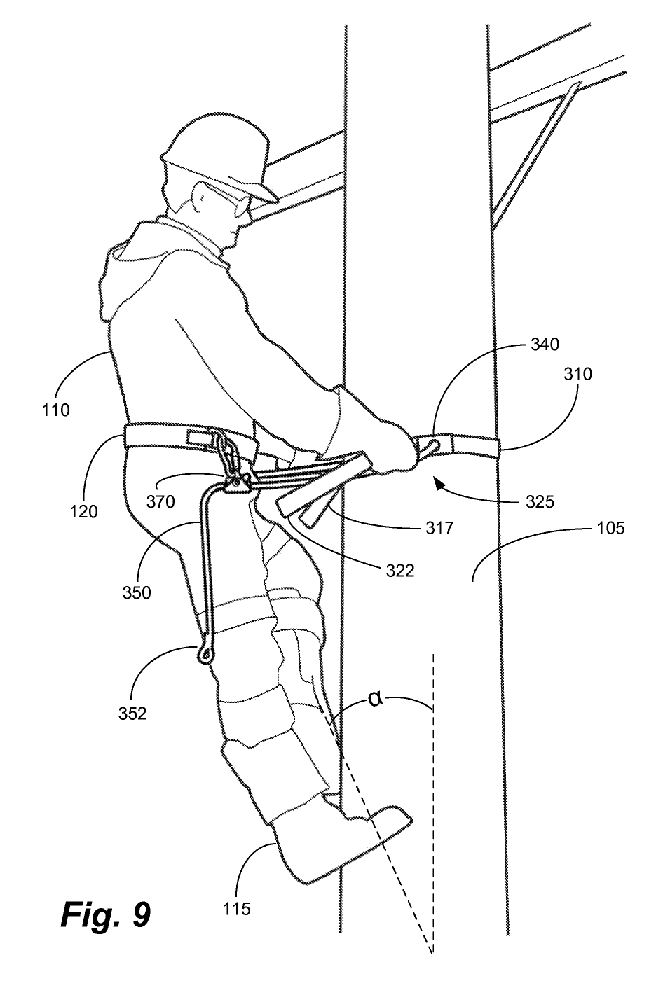

Embodiments of the present invention are shown in use in FIG. 9. In some embodiments, as the lineman 110 ascends the pole 105, he can be attached to the inner strap assembly 305 of the system 325 via the fastening means 370. In some embodiments, as the lineman 110 climbs, he can use the first ends 317, 322 of the outer strap assembly 310 to maneuver the system 325 up the pole 105. To ease movement of the system 325, the lineman 110 can also retract the handles 360 on the inner strap assembly 305 to increase the size of the loop 307 around the pole 105. If the lineman 110 wishes to alter his angle α with respect to the pole 105, he can increase or decrease the length of the first ends 347, 352 of the inner strap assembly 305 of the belt where they pass through the locks 370a.

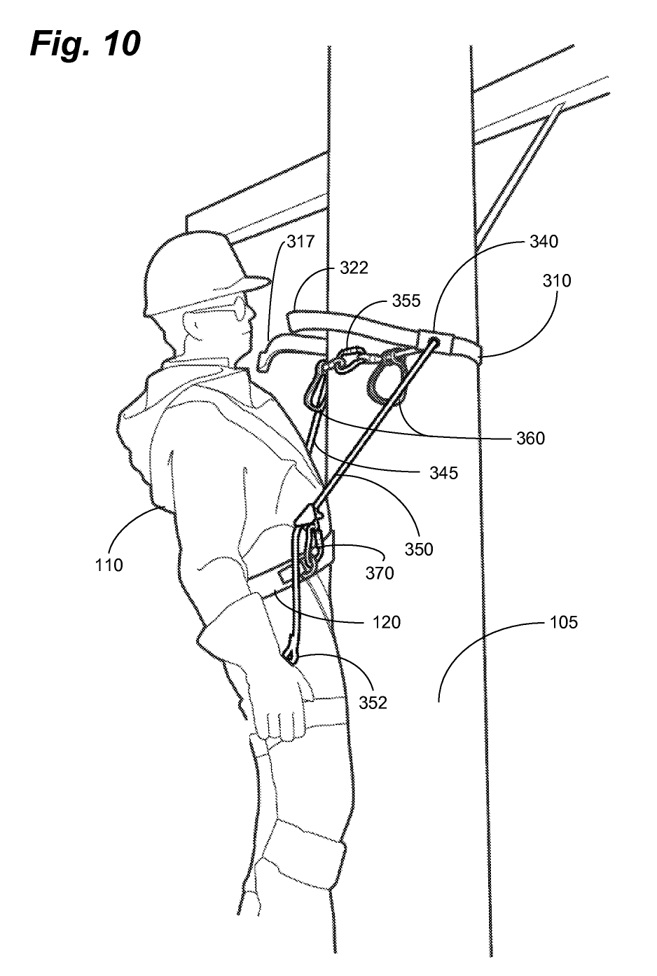

As shown in FIG. 10, if the lineman 110 starts to fall from the pole 105, his fall is arrested almost immediately. In some embodiments, when the lineman 110 falls, his weight is transferred, via the fastening means 370 attached to his harness 120, to the inner strap assembly 305 of the system 325. In some embodiments, the inner strap assembly 305 tightens around the pole 105 and the loop 307 formed by the inner 305 and outer 310 portions of the system 325 clamp tightly around the pole 105. The lineman's weight pulls the inner strap assembly 305, and thus immediately tightens the loop 307 around the pole 105.

As mentioned above, in some embodiments, the brackets 335, 340 on the outer strap assembly 310 of the system 325 can include friction multipliers 510, 625. In some embodiments, therefore, as the inner strap assembly 305 tightens due to the weight of the lineman 110, the brackets 335, 340, and this the friction multipliers 510, 625 are forced against the surface of the pole 105. In some embodiments, this can supplement the frictional force applied to the pole 105 by the inner 305 and outer strap assembly 310 of the system 325. In some embodiments, this can increase the weight limit of the system 325 and can improve, i.e., shorten, stopping distances during a fall.

While several possible embodiments are disclosed above, embodiments of the present invention are not so limited. For instance, different fastening devices 355, 370b could be used without departing from the spirit of embodiments of the invention. In addition, the order used for various features of the method of using embodiments of the present invention can be varied according to a particular work area that requires a slight variation in the method due to, for example, space constraints. Such changes are intended to be embraced within the scope of the invention.

From the forgoing, it can be seen that embodiments of the present invention provide a system 325 and methods 700, 800 for safely climbing and working on and around power poles 105. In some embodiments, the present invention is a system 325 capable of safely arresting and supporting a lineman 110 that has fallen from a power pole 105. In some embodiments, the system 325 can comprise inner 305 and outer 310 portions that comprise a loop 307 for encircling a pole 105. In some embodiments, the outer strap assembly 310 of the system 325 can comprise a strong, stiff material, while the inner strap assembly 305 of the system 325 can comprise a strong, supple material. In some embodiments, the lineman 110 can be attached to the system 325 via fastening means 370 provided on the inner strap assembly 305 of the system 325.

From the foregoing, it can also be seen that embodiments of the invention provide a number of different systems and methods 700, 800, which can be used to enable a lineman to safely climb a pole 105 to affect repairs. The system 325 can be easily adjusted to conform to a variety of poles 105 and a variety of linemen 110. Installed, embodiments of the present invention provide a safe solution to this ubiquitous problem. The various embodiments of the invention described above provide methods of using the belt and method when compared with prior approaches.

It will be appreciated by those skilled in the art, however, that the invention can be embodied in other specific forms without departing from the spirit or essential characteristics thereof. For example, embodiments of the invention have been described with respect to a method 700, 800 of using the system 325; however, the method 700, 800 could be performed using a different sequence of steps, or omitting certain steps, without deviating from the spirit of the invention. In addition, while the invention has been described in the context of system 325 for arresting a lineman 110, the concepts described herein need not be limited to these illustrative embodiments. For example, embodiments of the present invention could be used in many situations in which a user wished to climb a relatively narrow structure, such as, for example and not limitation, a ranger who wishes to climb a tree to survey an area of forest.

The specific configurations, choice of materials, and the size and shape of various elements could be varied according to particular design specifications or constraints requiring a device, system, or method constructed according to the principles of the invention. Such changes are intended to be embraced within the scope of the invention. The presently disclosed embodiments, therefore, are considered in all respects to be illustrative and not restrictive. The scope of the invention is indicated by the appended claims, rather than the foregoing description, and all changes that come within the meaning and range of equivalents thereof are intended to be embraced therein.

What is claimed is:

1. A fall arrest system comprising:
an outer strap assembly comprising a first outer strap, the first outer strap comprising a first end which is free-floating and a second end which is free-floating, and
an inner strap assembly comprising a first inner strap and a second inner strap, a second end of the first inner strap coupleable to a second end of the second inner strap;
a first bracket in communication with the outer strap assembly, the first bracket defining a first aperture; and
a second bracket in communication with the outer strap assembly, the second bracket defining a second aperture;
wherein the first aperture receives the first inner strap;
wherein the second aperture receives the second inner strap; and
wherein a portion of the first outer strap, a portion of the first inner strap, and a portion of the second inner strap substantially form a loop for surrounding a structure.

2. The system of claim 1, the inner strap assembly further comprising a coupling assembly, for detachably coupling the second ends of the first inner strap and the second inner strap.

3. The system of claim 1, further comprising an attachment means further comprising:
a coupling assembly for detachably coupling the system to a harness on a user; and
a lock for fixing the location of the coupling assembly along the inner strap assembly.

4. The system of claim 1, the outer strap assembly further comprising:
a second outer strap comprising a first end and a second end, the first end of the second outer strap being free-floating;
an adjusting element comprising a first end and a second end, the first end of the adjusting element pivotally coupled to a second end of the first bracket, and the second end of the adjusting element is slideably engageable with the second outer strap;
wherein a portion of the first bracket is coupled in proximity to the second end of the first outer strap;
wherein the second bracket is coupled to the second outer strap and disposed between the first end and the second end of the second outer strap;
wherein the size of the loop can be adjusted by sliding the second outer strap back and forth when the adjusting element is in a first, unlocked, position; and
wherein the size of the loop can be fixed when the adjusting element is in a second, locked, position, thereby preventing the second outer strap from sliding back and forth within the adjusting element.

5. The system of claim 4, wherein the free-floating first ends of the first and second outer straps provide handles with which a user can manipulate the fall arrest system.

6. The system of claim 4, wherein one or more of the first and second brackets further comprise a friction multiplier to increase the friction of the brackets against the structure.

7. The system of claim 4, the second end of the second outer strap further comprising a stop for preventing the second outer strap from disengaging from the adjusting element.

8. The system of claim 1, the inner strap assembly further comprising one or more handles located proximate the second ends of the inner straps for retracting the inner strap assembly away from the second side of the structure for temporarily increasing the size of the loop.

9. A method of placing a fall arrest system around a structure, the fall arrest system comprising an inner strap assembly and an outer strap assembly, the method comprising:
adjusting the length of the outer strap assembly to substantially encircle a first side of the structure;
coupling a first strap of the inner strap assembly to a second strap of the inner strap assembly, wherein the inner strap assembly substantially encircles a second side of the structure, and wherein the inner strap assembly and the outer strap assembly substantially form a loop that encircles both sides of the structure; and
coupling the inner strap assembly to a harness on a user such that the user's weight substantially closes the loop around the structure.

10. The method of claim 9, further comprising:
adjusting the angle of the user with respect to the structure by adjusting the length of the inner strap assembly where it couples to the harness.

11. The method of claim 9, further comprising:
grasping a first free-floating end and a second free-floating end of the outer strap assembly;
grasping the inner strap assembly and retracting it away from the second side of the structure;
repositioning the outer strap assembly using the first free-floating end and the second free-floating end to maintain the position of the safety belt relative to the user as he climbs up or down the structure; and
releasing the inner strap assembly such that the user's weight substantially closes the loop around the structure.

12. The method of claim 11, the inner strap assembly further comprising one or more handles for retracting the inner strap assembly away from the second side of the structure.

13. The method of claim 9, wherein the system is coupled to the harness using one or more coupling assemblies disposed on the inner strap assembly and outside the outer strap assembly.

14. A fall arrest system detachably coupleable to a harness on a user for preventing a user from falling off a structure, the system comprising:
an outer strap assembly, comprising:
a first outer strap comprising a first end and a second end, the first end of the first outer strap being free-floating;
a second outer strap comprising a first end and a second end, the first end of the second outer strap being free-floating;
a first bracket comprising a first end and a second end and defining a first aperture, the first end of the first bracket coupled in proximity to the second end of the first outer strap;
an adjusting element comprising a first end and a second end, the first end of the adjusting element pivotally coupled to the second end of the first bracket, and the second end of the adjusting element slideable along a portion of the second outer strap; and
a second bracket defining a second aperture, coupled to the second outer strap, and disposed between the first end and the second end of the second outer strap;
an inner strap assembly comprising a first end, a middle, and a second end, for encircling a second side of the structure, the first end second ends of the inner strap assembly being substantially free-floating;
a first attachment means disposed between the first end of the inner strap assembly and the first bracket, for attaching the inner strap assembly to a harness worn by a user; and
a second attachment means disposed between the second end of the inner strap assembly and the second bracket, for attaching the inner strap assembly to a harness worn by a user;
wherein the inner strap assembly passes through the first aperture and the second aperture, such that the middle of the inner strap assembly is disposed between the first aperture and the second aperture and inside the outer strap assembly;
wherein the first and second ends of the inner strap assembly are disposed outside the outer strap assembly, and such that portions of the outer strap assembly and portions of the inner strap assembly substantially form a loop around the structure;
wherein the size of the loop can be adjusted by sliding the second outer strap back and forth where it engages the adjusting element by placing the adjusting element in a first, unlocked, position; and
wherein the size of the loop can be fixed by placing the adjusting element in a second, locked, position, thereby preventing the second outer strap from sliding back and forth within the adjusting element.

15. The device of claim 14, the inner strap assembly further comprising:
a first inner strap comprising a first end and a second end, the first end of the first inner strap being free-floating;
a second inner strap comprising a first end and a second end, the first end of the second inner strap being free-floating; and
a coupling assembly detachably coupleable to the second ends of the first and second inner straps;
wherein the second ends of the first and second inner straps are disposed inside the outer strap assembly; and
wherein the first ends of the first and second inner straps are disposed outside the outer strap assembly.

16. The device of claim 14, the adjusting element further comprising a cam comprising a first position and a second position;
wherein, in the first position, the cam enables the second outer strap to move freely in a first direction but prevents movement of the second outer strap in a second direction; and
wherein the cam enables the second outer strap to move freely in both the first and second directions in a second position.

17. The device of claim 14, further comprising one or more handles disposed proximate the second ends of the first and second inner straps for increasing the size of the loop.

18. The device of claim 14, the attachment means further comprising:
a coupling assembly comprising a first end and a second end, the first end of the coupling assembly detachably coupleable to the harness; and
a lock comprising a first end and a second end, the first end of the lock coupleable to the coupling assembly and the second end of the lock slideably coupleable to the inner strap assembly;
wherein in a first position the lock prevents movement of the attachment means along the inner strap assembly; and
wherein in a second position the lock enables the attachment means to slide along the inner strap assembly outside the outer strap assembly.

19. The device of claim 18, wherein the lock further comprises a cam
wherein in a first position the cam enables movement of the attachment means along the inner strap assembly in a first direction, but prevents movement along the inner strap assembly in a second direction; and
wherein in a second position the cam enables movement of the attachment means along the inner strap assembly in both the first and second directions.

20. The system of claim 14, wherein one or more of the first and second brackets further comprise a friction multiplier to increase the friction of the brackets against the structure.
